(19) United States
(12) Patent Application Publication
(10) Pub. No.: US 2013/0110958 A1
(43) Pub. Date: May 2, 2013

(54) METHOD, SYSTEM, AND CONVERSION DEVICE FOR WIRELESS COMMUNICATIONS FOR HOSTS OF HUMAN INTERFACE DEVICES

(71) Applicants: Tsung-Ching KAO, New Taipei City (TW); Kao-Huang LIN, New Taipei City (TW)

(72) Inventors: Tsung-Ching KAO, New Taipei City (TW); Kao-Huang LIN, New Taipei City (TW)

(21) Appl. No.: 13/407,240

(22) Filed: Feb. 28, 2012

(30) Foreign Application Priority Data
Nov. 1, 2011 (TW) 100139791

(51) Int. Cl. G06F 15/16

(52) U.S. Cl. 709/208

(57) ABSTRACT

This invention presents a method, a system, and a conversion device for wireless communications for the hosts of Human Interface Device (HID hosts), the system thereof comprises at least one host equipped with HID host as first electronic device, such as desktop computer, tablet PC, network TV and so on; at least one host equipped with HID host as second electronic device, such as cell phone, tablet PC, or other mobile devices; and at least one conversion device for wireless communication, which is externally connected to or internally embedded in, and mechanically attached to and electronically linked to the first electronic device, reports that the first electronic device being equipped HID and enables the second electronic device converted to a HID via the conversion device for wireless communication, thereby communicates wirelessly with the first electronic device, and further controls or performs input function to the first electronic device.

### BACKGROUND OF INVENTION

This invention is related to a method, a system, and a conversion device for wireless communications for at least two hosts of human interface device (HID hosts), particularly related to the conversion device which enables one HID-converted host sending input or control signals to the other host via wireless communication.

This invention is related to a method, a system, and a conversion device for wireless communications for at least two hosts of human interface device (HID hosts), particularly converts one of the two hosts to an HID device such that at least one host is able to be used for control or input to the other host via wireless communication.

Under most of application circumstances, the hosts are designed for the users performing input activities, such that the hosts receive the users' commands, and execute the desirable tasks and functions.

Under current commercially available architectures of the prior arts, the users normally have to use a specific or a dedicated HID, namely a piece of hardware, such as a wireless mouse, a wireless keyboard, a wireless presentation pen, a Bluetooth mouse, a Bluetooth keyboard, a Bluetooth presentation pen, etc., for performing input activities, for example: using existing technologies for data input to or for function control over a set of electronic equipment via wireless, the users need to go through a dedicated piece of hardware, such as performing input or control on a computer, the interface device used therein being a wireless mouse, which normally comprising a wireless transmitter in the wireless mouse, and a USB wireless receiver, which attached to the computer, or a Bluetooth keyboard therein embedded with a Bluetooth transmitter and a Bluetooth mouse therein embedded with a Bluetooth transmitter, or wireless presentation pen, Bluetooth presentation pen and various types of HID wireless hardware; or the users control a TV set via wireless controller.

However, after the rapid adoption of cell phones, tablet computers, and other mobile devices, people began to ponder about how to take advantage of the resources in a mobile device for the purpose of input to or control over another electronic devices via wireless mechanisms, thereby one of the popular approaches is taking advantage of the built-in keyboard, touch screen, infrared module (such as 1394 interface), or WiFi module.

Among the approaches, the problem of using infrared module is that in the current market place, the cell phones or wireless devices with embedded infrared module become less popular, moreover those devices embedded with infrared module, which is further facilitated by the interface and control software, can only control the electronic devices, equipments, or facilities embedded with infrared modules, and therefore only replace the function of control, which is limited in terms of functionality and efficiency.

In the case of using WiFi as wireless interface, the prior arts disclose that the use of the WiFi devices for input and control are communicating with the WiFi devices or modules of the electronic devices, equipments, or facilities under control or functional execution, thereby both WiFi-enable devices need to install WiFi-related software with the proper settings in order to allow the users going through the said networking and performing the desirable tasks. This is a rather inconvenient in case that the said network shutdowns and subsequently disables the communication links; or the users need to reset dynamic IP address when they moving out the coverage of the said network, moreover, the users may enter a zone without WiFi support, and therein the users are not able to use the devices. Therefore the problems of the prior arts are that the dedicated devices of hardware are mostly not portable, and the mobile devices are subjected to the available WiFi coverage.

As various types of portable and mobile HID hosts, such as cell phone, tablet, and notebook computer etc., become increasing popular as well as awareness of the environment protection is prevailing, people began to think seriously of taking advantage of one or more than one hosts for input or control over the other or another hosts, and nowadays make progress mainly by going through the Internet or wired connections, to link two hosts, and allow the users perform input activities on one of the hosts and thereby command the other host, however, encounter technical issues such as setup problem, host compatible problem, cable/interface compatible problem etc.

In addition, the prior arts provide a single HID device via wired or wireless link, connect the HID device to the designated host, and subsequently allow the users performing input activities through the HID device. After the different hosts and networks become popular, the products and inventions of input to a host through the other host are thereafter emerging.

However, the aforementioned two prior arts providing a dedicated HID for input to the designated hosts result in several HID devices for the corresponding numbers of the said hosts, for instance, the users, who taking a dedicated keyboard and/or mouse for input to a computer or a cell phone, will feel inconveniently and face energy inefficiently situations; or who taking advantage of networking for performing the same task, will encounter software/hardware compatibility problem and network shutdown situation and therefore face same inconvenience.

This invention proposes an effective solution for using a host for input to at least one of another hosts.

### SUMMARY OF INVENTION

The primary object of this invention is to provide a method, a system, and a conversion device thereof for wireless communications for at least two the hosts of Human Interface Device (HID host), the system hereof comprises at least one host equipped with HID for input and control functions via wireless communication for solving the problems of using a dedicated HID device or going through the Internet as provided by the prior arts for input to another host from a host.

In order to furnish this object, the invention hereby focuses on at least two hosts, wherein the hosts hereby defined as the electronic device equipped with the functions of HID host, at least one as first electronic device and at least one as second electronic device; the invention primarily provides one wireless communication conversion device, which is electronically linked to the said first electronic device, therefrom reports that the said first electronic device being equipped with HID, and thereby enables the said second electronic device converted to a HID via the conversion device for wireless communication, communicates wirelessly with the said first electronic device, and further controls or performs input function to the said first electronic device.

In one of the preferred embodiments, wherein the first electronic device comprises therein one type, or two types, or combination of more than two types of desktop PC, notebook PC, tablet, IPTV, industrial computer.

In one of the preferred embodiments, wherein the second electronic device comprises therein one type, or two types, or combination of more than two types of cell phone, tablet, and related mobile devices.

In one of the preferred embodiments, wherein the conversion device for wireless communication comprises therein at least a controller therefrom reports that the said first electronic device being equipped with Human Interface Device (HID), and enables the said second electronic device converted to an HID via the conversion device for wireless communication, thereby communicates wirelessly with the said first electronic device.

In one of the preferred embodiments, wherein the conversion device for wireless communication is therein internally embedded in, mechanically attached to, and electronically linked to the said first electronic device.

In one of the preferred embodiments, wherein the conversion device for wireless communication forms therein a module, which provides an interface externally connected mechanically attached to, and electronically linked to the first electronic device; wherein the interface comprises but is not limited to USB (Universal Serial Bus), 1394 Interface, and Thunderbolt Interface (designed by Intel).

In one of the preferred embodiments, wherein the wireless communication comprises one standard, or two standards, or combination of more than two standards such as Bluetooth, WiFi, NFC (Near Field Communication), and other wireless standards for cell phones.

In one of the preferred embodiments, wherein the HID host converted from the second electronic device therein comprises one type, or two types, or combination of more than two types o keyboard, mouse, touch pad, and touch screen used for input and control to the first electronic device.

In one of the preferred embodiments, wherein the function of the HID host is internally embedded in or externally connected to the first electronic device as well as the second electronic device.

### BRIEF DESCRIPTION OF DRAWINGS

FIG. 1 explain the system architecture of host-to-host wireless communication wherein this invention applying to at least two HID hosts.

FIG. 2 is the functional block diagram of host-to-host wireless communication wherein this invention applying to at least two HID hosts.

FIG. 3 is the functional block diagram of the conversion device for wireless communication.

FIG. 4 through FIG. 11 is the functional block diagram corresponding to the individual preferred embodiment 1 through 8 (i.e., a second electronic device 2 executing input or control task to a first electronic device 1).

FIG. 12 is the functional block diagram corresponding to the preferred embodiment 9 (i.e., a plurality of second electronic device 2 executing input or control task to a first electronic device 1).

FIG. 13 is the functional block diagram corresponding to the preferred embodiment 10 (i.e., a second electronic device 2 executing input or control task to a plurality of first electronic device 1).

### DETAILED DESCRIPTION OF PREFERRED EMBODIMENT

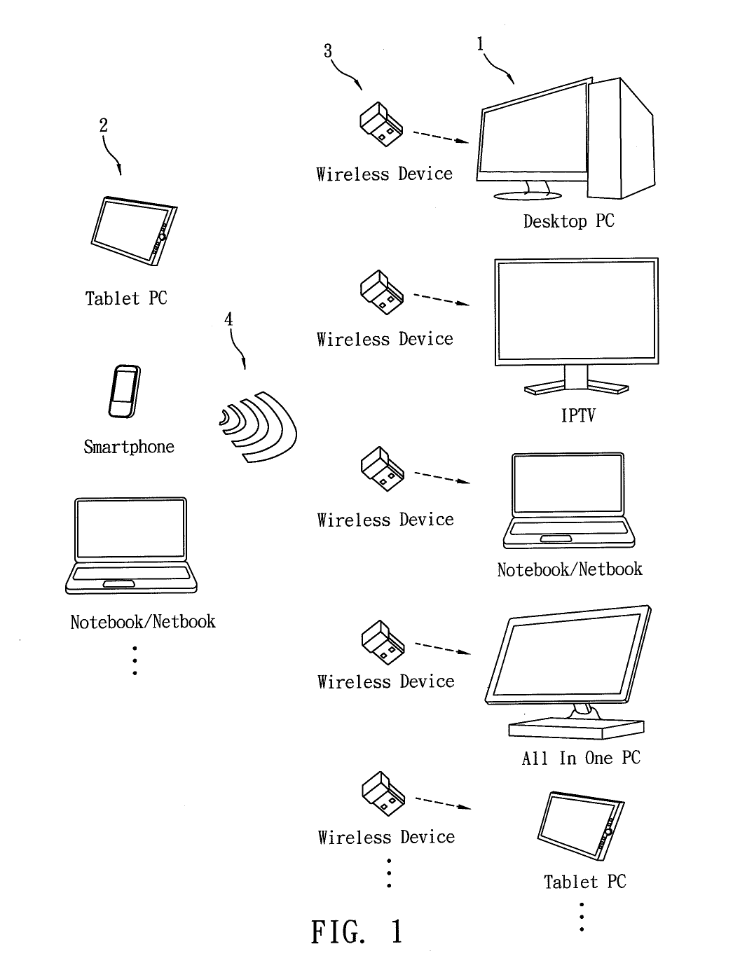

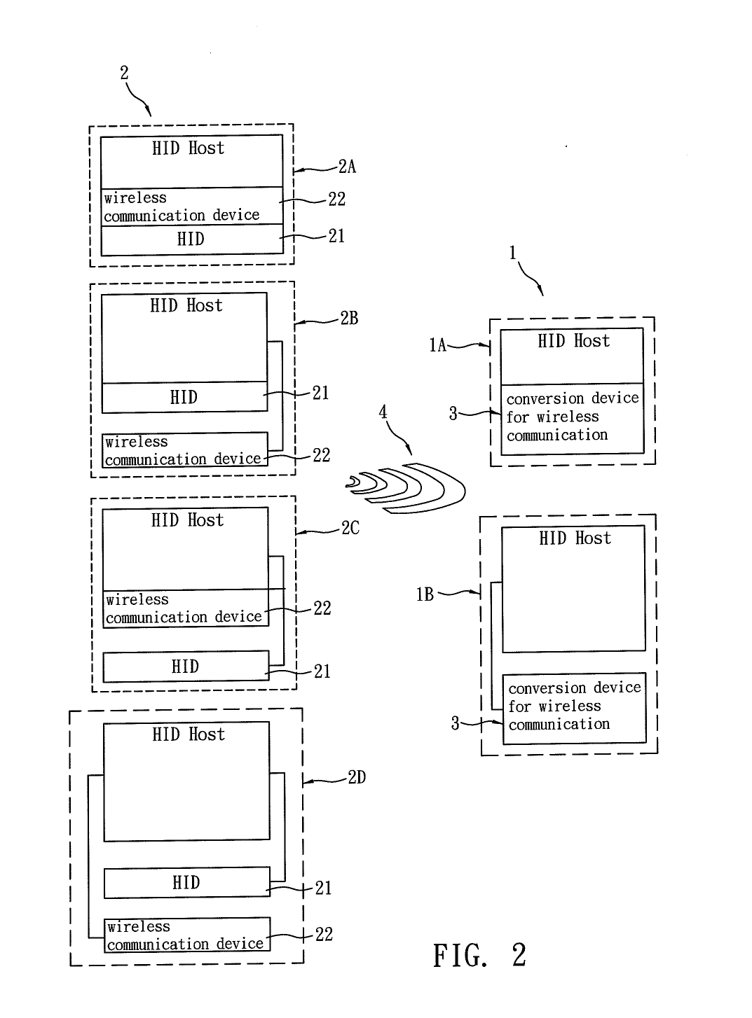

Referring to FIGS. 1 and 2, this invention applies to the host-to-host wireless communication of at least two Human Interface Device (HID) hosts 1, and 2, wherein the system comprises at least two electronic devices 1 and 2 with functionality of the HID and a least one conversion device for wireless communication 3; for the purpose of interpretation of this invention, we define thereafter the term “host” as the electronic devices 1 and 2 with functionality of the HID.

The primary technical feature of the invention is that at least a conversion device for wireless communication 3 therein connects to the first electronic device, therefrom reports the first electronic device 1 as an HID host, and thereby enables the second electronic device 2 converted to an HID host by the conversion device for wireless communication 3, and further performs the tasks of input or control to the first electronic device based on the wireless communication standards 4.

The first electronic device 1 of the invention therein comprises but is not limited to one type, or two types, or combination of more than two types of desktop PC, notebook PC, tablet, IPTV, industrial computer as shown in FIG. 1 and FIG. 2.

The second electronic device 2 of the invention therein comprises but is not limited to one type, or two types, or combination of more than two types of cell phone, tablet, and related mobile devices.

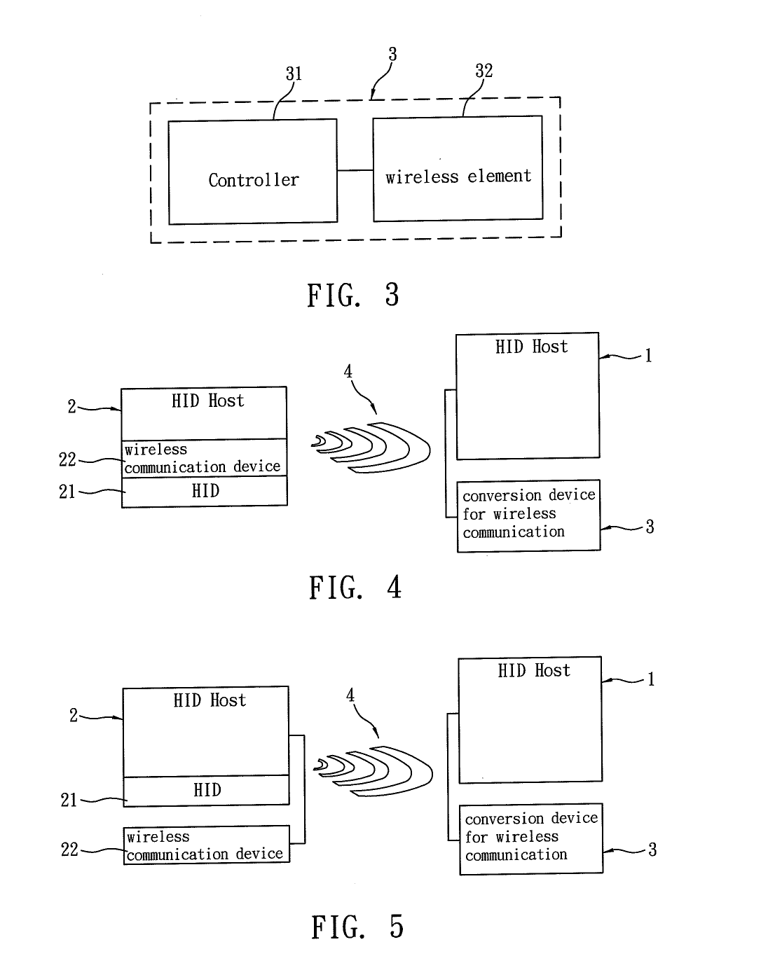

Referring to FIG. 3, the conversion device for wireless communication 3 of the invention therein comprises but is not limited to at least one controller 31 therefrom reporting the first electronic device 1 as an HID host, and at least one wireless element 32 thereby linking to the second electronic device 2 to the first electronic device based on wireless communication standards 4.

The installation of the conversion device for wireless communication 3 of the invention is not limited to the following approaches, for example, the conversion device for wireless communication 3 can be internally embedded in the first electronic device and electronically linked to the first electronic device as shown as linking mode 1A in FIG. 2. The conversion device for wireless communication 3 can also form as a single module as shown as individual module (3) in FIG. 1, thereby provides a connectable interface and connects externally to the first electronic device 1 as linking mode 1B shown in FIG. 2. The standards of the interface comprise but are not limited to USB (Universal Serial Bus), 1394 Interface, and Thunderbolt Interface (designed by Intel). One of the preferred embodiments of the invention is selecting USB as interface and inserting the conversion device for wireless communication 3 to the USB port (not shown) for connecting to the conversion device for wireless communication 3 to the first electronic device 1.

The second electronic device 2 of the invention links to the first electronic device 1 via the conversion device for wireless communication 3 based on wireless communication standards 4, wherein the wireless communication standards 4 comprise but are not limited to one standard, or two standards, or combination of more than two standards such as Bluetooth, WiFi, NFC (near Field Communication), other cell phone standards.

The second electronic device 2 of the invention is converted to a Human Interface Device (HID) via the conversion device for wireless communication 3, wherein the converted HID 2 from the second electronic device comprises but is not limited to one type, or two types, or combination of more than two types o keyboard, mouse, touch pad, and touch screen therein used for input and control to the first electronic device.

The hosts of the invention are hereby defined as the electronic devices 1, 2 equipped with the functions of Human Interface Device (HID Host), further the conversion device for wireless communication 3 is primarily to provide thereof linking to the first electronic device 1, therefore enables the second electronic device 2 can communicate with the first electronic device via the conversion device for wireless communication 3, and furthermore converts the second electronic device to an HID host for input and control to the first electronic device. Insomuch the second electronic device 2 and the first electronic device 1 are equipped with HID functions as shown as HID 21 in FIG. 2, in addition the second electronic device is equipped with at least one wireless communication module as shown as wireless communication device 22 in FIG. 2, wherein the HID 21 and wireless communication device 22 are installed not limited, namely, both can be embedded or externally connected to the second electronic device 2, for example, the HID 21 and wireless communication device 22 are both internally embedded in and connected to the second electronic device 2 as shown as connection mode 2A in FIG. 2; or the HID 21 and wireless communication device 22 are internally embedded in and external connected to the second electronic device 2 respectively as shown as connection mode 2B in FIG. 2; or the HID 21 and wireless communication device 22 are external connected and internally embedded in to the second electronic device 2 respectively as shown as connection mode 2C in FIG. 2; or the said HID 21 and wireless communication device 22 are both externally connected to the second electronic device 2 as shown as connection mode 2D in FIG. 2.

Moreover, this invention can be further implemented and functionally provided as follows: the users can take the HID-converted second electronic device 2, and perform input and control to the HID-converted first electronic device 1 via wireless communication.

In general, the first and second electronic devices 1, 2, which are equivalent to the hosts and are built-in with HID functionality, therein are allowed the users perform connection, in order to proceed input to the hosts; however, in this case the first and second electronic devices (namely hosts) 1, 2 are not equipped with built-in HID function, therefore, the first and second electronic devices 1, 2 cannot behave as HID for users to perform input activities to other host or hosts, which are functionally similar to the electronic devices 1, 2.

This invention mainly takes advantage of a conversion device for wireless communication 3 with report-back function, which being installed and linked to the first electronic device, and receiving input and control signals, wherein the installation approaches comprise but are not limited to the following connection modes: installing the conversion device for wireless communication 3 as an embedded module in the said first electronic device 1 as shown as connection mode 1A in FIG. 2, thereafter forming the said first electronic device 1 embedded with conversion device for wireless communication 3, and then providing the reception and execution of input and control wireless signals from the HID-converted second electronic device 2; or installing the conversion device for wireless communication 3 as an external module in the said first electronic device 1 as shown as connection mode 1B in FIG. 2, thereafter forming the said first electronic device embedded with conversion device for wireless communication 3, and then providing the reception and execution of input and control wireless signals from the said HID-converted second electronic device. And the said first electronic device 1 (namely host receiving input or control signals), which is installed with conversion device for wireless communication 3, detects the HID installation, and is ready to receiving input and control signals from the said HID-converted second electronic device.

The report-back device is an HID with a conversion device 3, which, on one hand, reporting that the first electronic device is converted to an HID, on the other hand, on the other hand, receiving wireless signals from the HID-converted second electronic device, and translating the received signals to the corresponding HID code, then passing to the said first electronic device for further processing and executing.

On the HID-converted host, namely the second electronic device 2, therein are installed an HID 21 and a wireless communication device 22, wherein the HID 21 and wireless communication device 22 can be installed internally and externally to the HID-convertible second electronic device 2, wherein the installation approaches comprise but are not limited to several connection modes, which are referred to the connection modes 2A, 2B, 2C, and 2D as shown in FIG. 2.

The system design applied to the HID-convertible second electronic device 2 therein facilitates the HID code input from the HID 21 processed therein through the wireless communication device 22 based on the corresponding wireless communication standards, and forwards the conversion devices for wireless communication 3, which further processing the data packets and transmitting to HID-converted first electronic device 1 for processing and executing.

Several preferred embodiments will be further illustrated in conjunction with the figures in the following:

### Embodiment 1

Referring to FIG. 4, an HID-converted host (namely the second electronic device 2) facilitates the HID code input from the embedded HID 21 processed therein through the embedded wireless communication device 22 (but not limited) to the Bluetooth standard, and forwards the conversion devices for wireless communication 3, which further processing the data packets and transmitting to the conversion device for Bluetooth standard 3, which is connected externally to an HID-converted host (namely the first electronic device 1). The conversion device for Bluetooth standard 3 removes the data envelops and forwards the HID code to receiving host (namely the first electronic device 1).

### Embodiment 2

Referring to FIG. 5, an HID-converted host (namely the second electronic device 2) facilitates the HID code input from the embedded HID 21 processed therein through the external wireless communication device 22 (but not limited) to the 2.4 GHz standards, and forwards the conversion devices for wireless communication 3, which further processing the data packets and transmitting to the conversion device for 2.4 GHz standard 3, which is connected externally to an HID-converted host (namely the first electronic device 1). The conversion device for 2.4 GHz standard 3 removes the data envelops and forwards the HID code to receiving host (namely the first electronic device 1).

### Embodiment 3

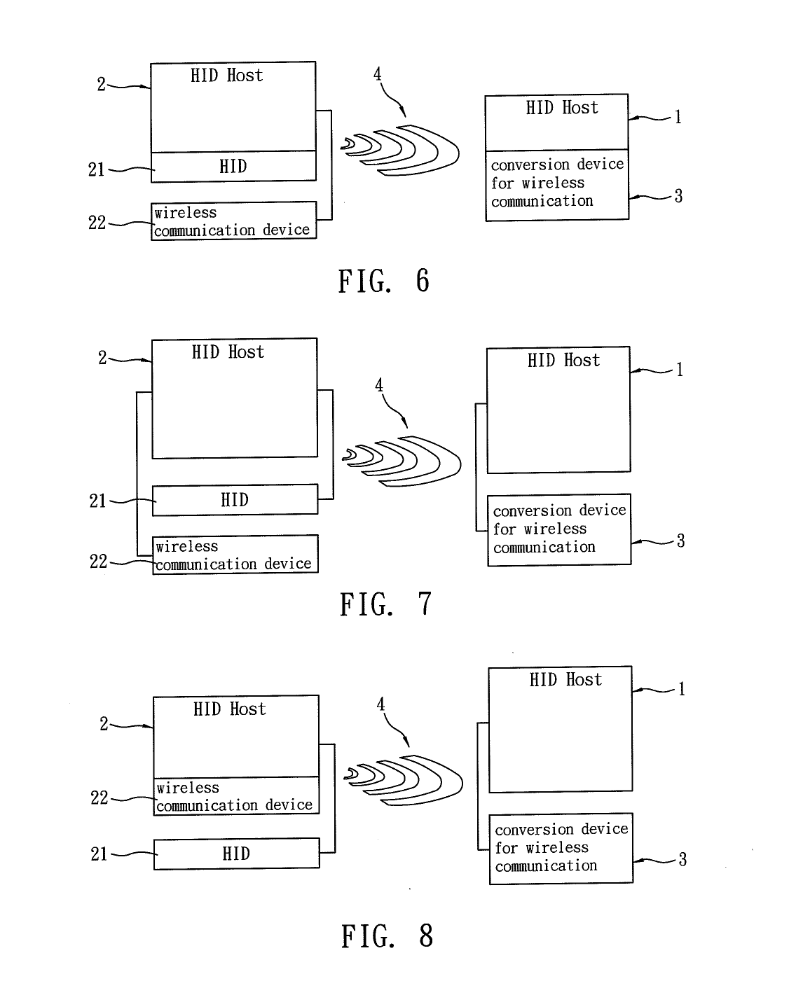

Referring to FIG. 6, an HID-converted host (namely the second electronic device 2) facilitates the HID code input from the embedded HID 21 processed therein through the external wireless communication device 22 (but not limited) to the Bluetooth standard, and forwards the conversion devices for wireless communication 3, which further processing the data packets and transmitting to the conversion device for Bluetooth standard 3, which is connected internally to an HID-converted host (namely the first electronic device 1). The conversion device for Bluetooth standard 3 removes the data envelops and forwards the HID code to receiving host (namely the first electronic device 1).

### Embodiment 4

Referring to FIG. 7, an HID-converted host (namely the second electronic device 2) facilitates the HID code input from the external HID 21 processed therein through the external wireless communication device 22 (but not limited) to the 2.4 GHz standard, and forwards the conversion devices for wireless communication 3, which further processing the data packets and transmitting to the conversion device for 2.4 GHz standard 3, which is connected externally to an HID-converted host (namely the first electronic device 1). The conversion device for 2.4 GHz standard 3 removes the data envelops and forwards the HID code to receiving host (namely first electronic device 1).

### Embodiment 5

Referring to FIG. 8, an HID-converted host (namely the second electronic device 2) facilitates the HID code input from the external HID 21 processed therein through the embedded wireless communication device 22 (but not limited) to the Bluetooth standard, and forwards the conversion devices for wireless communication 3, which further processing the data packets and transmitting to the conversion device for Bluetooth standard 3, which is connected externally to an HID-converted host (namely the first electronic device 1). The conversion device for Bluetooth standard 3 removes the data envelops and forwards the HID code to receiving host (namely first electronic device 1).

### Embodiment 6

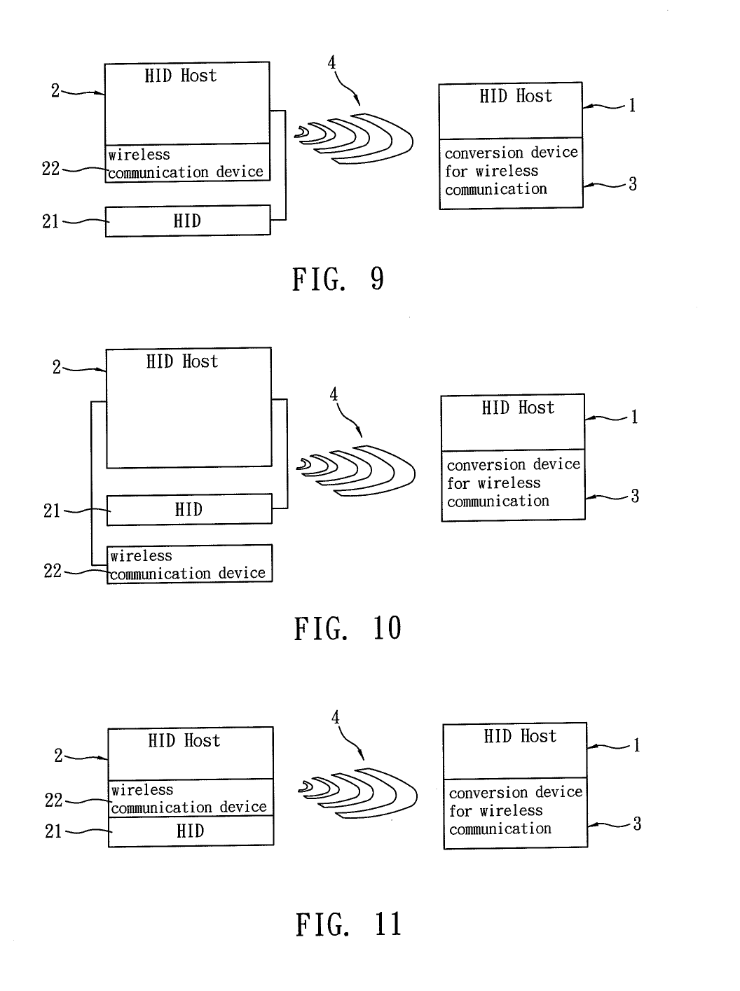

Referring to FIG. 9, an HID-converted host (namely the second electronic device 2) facilitates the HID code input from the external HID 21 processed therein through the embedded wireless communication device 22 (but not limited) to the Bluetooth standard, and forwards the conversion devices for wireless communication 3, which further processing the data packets and transmitting to the conversion device for Bluetooth standard 3, which is connected internally to an HID-converted host (namely the first electronic device 1). The conversion device for Bluetooth standard 3 removes the data envelops and forwards the HID code to receiving host (namely first electronic device 1).

### Embodiment 7

Referring to FIG. 10, an HID-converted host (namely the second electronic device 2) facilitates the HID code input from the external HID 21 processed therein through the external wireless communication device 22 (but not limited) to the Bluetooth standard, and forwards the conversion devices for wireless communication 3, which further processing the data packets and transmitting to the conversion device for Bluetooth standard 3, which is connected internally to an HID-converted host (namely the first electronic device 1). The conversion device for Bluetooth standard 3 removes the data envelops and forwards the HID code to receiving host (namely first electronic device 1).

### Embodiment 8

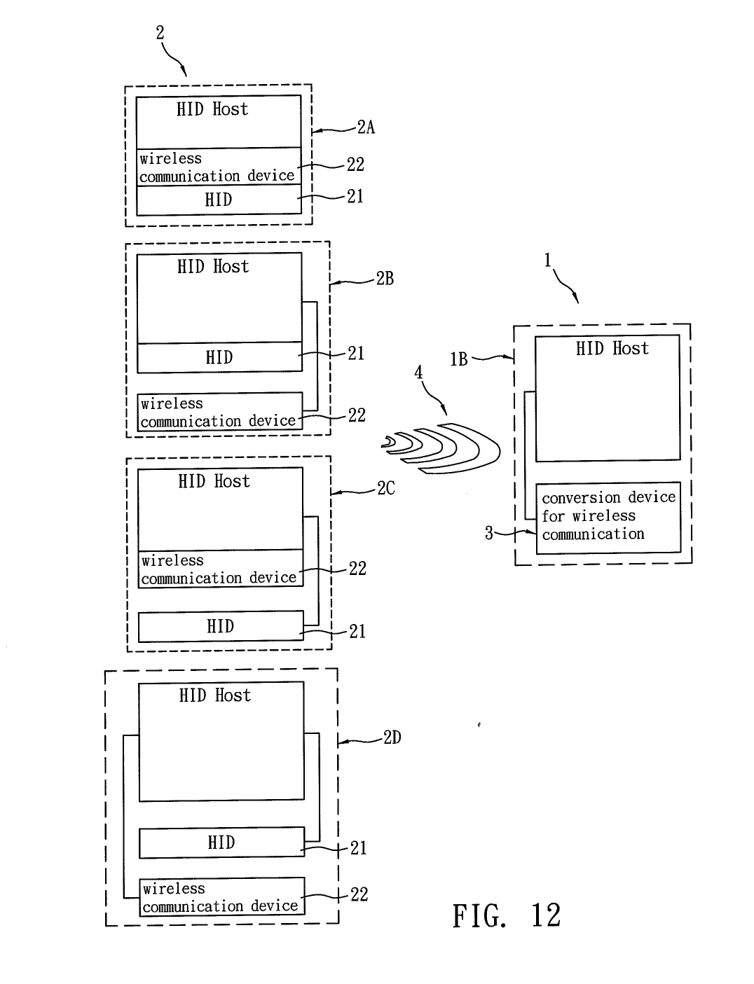

Referring to FIG. 11, an HID-converted host (namely the second electronic device 2) facilitates the HID code input from the embedded HID 21 processed therein through the embedded wireless communication device 22 to (but not limited) the Bluetooth standard, and forwards the conversion devices for wireless communication 3, which further processing the data packets and transmitting to the conversion device for Bluetooth standard 3, which is connected internally to an HID-converted host (namely the first electronic device 1). The conversion device for Bluetooth standard 3 removes the data envelops and forwards the HID code to receiving host (namely the first electronic device 1).

### Embodiment 9

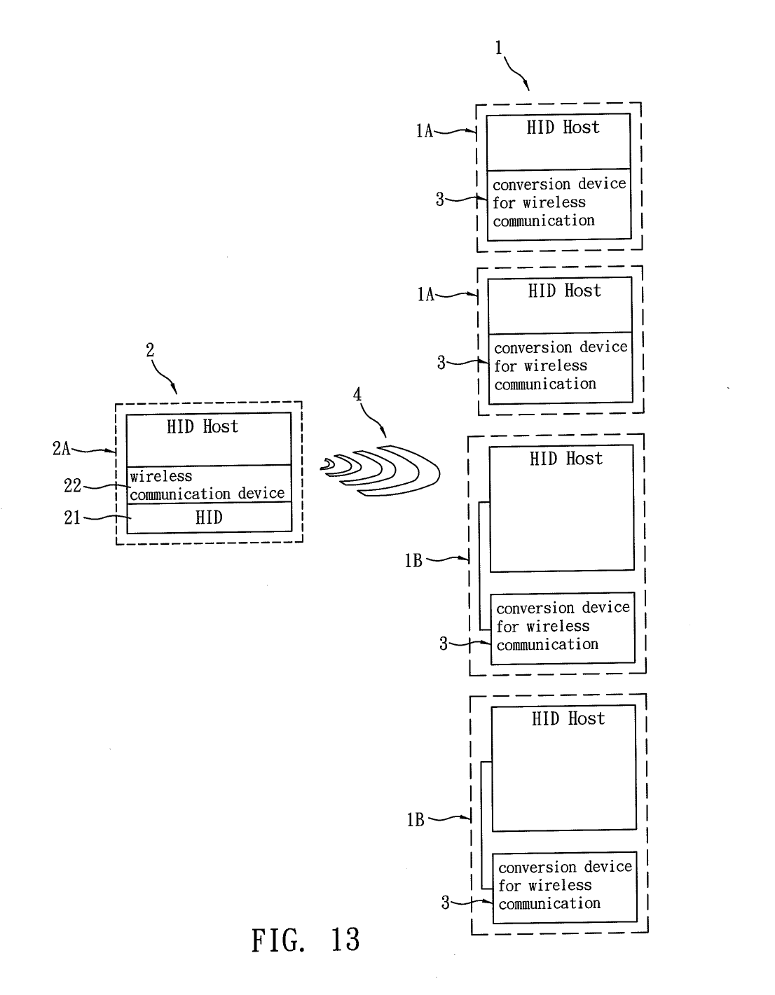

Referring to FIG. 12, a plurality of HID-converted hosts (namely multiple second electronic devices 2) facilitate the HID code input from the embedded/external HID 21 processed therein through the embedded/external wireless communication device 22 (but not limited) to the Bluetooth standard, and forwards the conversion devices for wireless communication 3, which further processing the data packets and transmitting to the conversion device for Bluetooth standard 3, which is connected internally/externally to an HID-converted host (namely the first electronic device 1). The conversion device for Bluetooth standard 3 removes the data envelops and forwards the HID code to receiving host (namely the first electronic device 1). This embodiment represents a plurality of HID-converted hosts (namely multiple second electronic devices 2) transmit input and control wireless signals to an HID-converted host (namely the first electronic device 1).

### Embodiment 10

Referring to FIG. 13, an HID-converted hosts (namely multiple second electronic devices 2) facilitates the HID code input from the embedded/external HID 21 processed therein through the embedded/external wireless communication device 22 (but not limited) to the Bluetooth standard, and forwards the conversion devices for wireless communication 3, which further processing the data packets and transmitting to a plurality of conversion device for Bluetooth standard 3, which is individually connected internally/externally to a plurality of HID-converted host (namely first electronic device 1) respectively. Each individual conversion device for Bluetooth standard 3 removes the data envelops and forwards the HID code to the connected receiving host (namely the first electronic device 1). This embodiment represents an HID-converted hosts (namely multiple second electronic devices 2) transmits input and control wireless signals to a plurality of HID-converted host (namely the first electronic device 1).

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method applied to the wireless communication of at least two Human Interface Device (HID) hosts, comprising:
providing at least two electronic devices with functionality of HID hosts, therein comprising at least a first electronic device and a second electronic device;
providing a conversion device for wireless communication thereby connecting to the first electronic device, subsequently furnishing the first electronic device to report as an HID, and providing the second electronic device to connect to the first electronic device via the said conversion device for wireless communication based on the wireless communication standards, and thereby enabling the first electronic device to receive the wireless signals from the second electronic device; and
making the said conversion device for wireless communication to convert the second electronic device to an HID for use to perform input and control tasks to the first electronic device.

2. A method applied to the wireless communication as claimed in claim 1, wherein the said first electronic device comprises therein one type, or two types, or combination of more than two types of desktop PC, notebook PC, tablet, IPTV, industrial computer.

3. A method applied to the wireless communication as claimed in claim 1, wherein the said second electronic device comprises therein one type, or two types, or combination of more than two types of cell phone, tablet, and related mobile devices.

4. A method applied to the wireless communication as claimed in claim 1, wherein the said conversion device for wireless communication comprises therein at least a controller thereby reports that the said first electronic device being equipped with Human Interface Device (HID), and at least a wireless element thereby enables the said second electronic device wirelessly communicates with the said first electronic device.

5. A method applied to the wireless communication as claimed in claim 1, wherein the said conversion device for wireless communication is therein internally embedded in, mechanically attached to, and electronically linked to the said first electronic device.

6. A method applied to the wireless communication as claimed in claim 1, wherein the said conversion device for wireless communication forms therein a module, which provides an interface externally connected, mechanically attached to, and electronically linked to the said first electronic device.

7. A method applied to the wireless communication as claimed in claim 6, wherein the module of the said conversion device for wireless communication therein uses USB (Universal Series Bus) as an interface thereby externally connects with the said first electronic device.

8. A method applied to the wireless communication as claimed in claim 1, wherein the said wireless communication comprises one standard, or two standards, or combination of more than two standards such as Bluetooth, WiFi, NFC (Near Field Communication), wireless RF transceivers.

9. A method applied to the wireless communication as claimed in claim 1, wherein the said HID converted from the said second electronic device therein comprises one type, or two types, or combination of more than two types o keyboard, mouse, touch pad, and touch screen used for input and control to the said first electronic device.

10. A method applied to the wireless communication as claimed in claim 1, wherein the said functionality of the said HID host is therein embedded or externally constructed in the said first electronic device and the said second electronic device.

11. A method applied to the wireless communication as claimed in claim 1, wherein a plurality of said second electronic device transmit input and control wireless signals to a single said first electronic device.

12. A method applied to the wireless communication as claimed in claim 1, wherein a single said second electronic device transmits input and control wireless signals to a plurality of said first electronic device.

13. A system applied to the wireless communication of at least two Human Interface Device (HID) hosts, comprising:
at least two electronic devices with functionality of HID hosts therein comprising at least a first electronic device and a second electronic device; and
at least one conversion device for wireless communication, thereby connecting to the said first electronic device, subsequently furnishing the said first electronic device to report as an HID, and providing the said second electronic device to connect to the said first electronic device via the said conversion device for wireless communication based on the wireless communication standards, and thereby enabling the said second electronic device to transmit the wireless signals to the said first electronic device, and performs input and control tasks to the said first electronic device.

14. A system applied to the wireless communication as claimed in claim 13, wherein the said first electronic device comprises therein one type, or two types, or combination of more than two types of desktop PC, notebook PC, tablet, IPTV, industrial computer.

15. A system applied to the wireless communication as claimed in claim 13, wherein the said second electronic device comprises therein one type, or two types, or combination of more than two types of cell phone, tablet, and related mobile devices.

16. A system applied to the wireless communication as claimed in claim 13, wherein the said conversion device for wireless communication comprises therein at least a controller thereby reports that the said first electronic device being equipped with Human Interface Device (HID), and thereby enables the said second electronic device wirelessly communicates with the said first electronic device.

17. A system applied to the wireless communication as claimed in claim 13, wherein the said conversion device for wireless communication is therein internally embedded in, mechanically attached to, and electronically linked to the said first electronic device.

18. A system applied to the wireless communication as claimed in claim 13, wherein the said conversion device for wireless communication forms therein a module, which provides an interface externally connected, mechanically attached to, and electronically linked to the said first electronic device.

19. A system applied to the wireless communication as claimed in claim 18, wherein the said module of the said conversion device for wireless communication therein uses USB (Universal Series Bus) as an interface thereby externally connects with the said first electronic device.

20. A system applied to the wireless communication as claimed in claim 13, wherein the said wireless communication comprises one standard, or two standards, or combination of more than two standards such as Bluetooth, WiFi, NFC (Near Field Communication), wireless RF transceivers.

21. A system applied to the wireless communication as claimed in claim 13, wherein the said
HID converted from the said second electronic device therein comprises therein one type, or two types, or combination of more than two types o keyboard, mouse, touch pad, and touch screen therein used for input and control to the said first electronic device.

22. A system applied to the wireless communication as claimed in claim 13, wherein the said functionality of the said HID host is therein embedded or externally constructed in the said first electronic device and the said second electronic device.

23. A conversion device for wireless communication applied to the wireless communication of at least two Human Interface Device (HID) hosts, wherein the HID hosts being furnished by at least two electronic devices with functionality of HID hosts, therein comprising at least a first electronic device and a second electronic device; the said conversion device for wireless communication is connected to the said first electronic device, comprising:
at least a controller thereby reports that the said first electronic device being equipped with the Human Interface Device (HID); and
at least one wireless element thereby providing the said second electronic device to communicate with the said first electronic device;
wherein the said conversion device for wireless communication converting the said second electronic device to an HID for use to perform input and control tasks to the said first electronic device.

24. A conversion device for wireless communication as claim in claim 23, wherein the said conversion device is therein internally embedded in, mechanically attached to, and electronically linked to the said first electronic device.

25. A conversion device for wireless communication as claim in claim 23, wherein the said conversion device forms therein a module, which provides an interface externally connected to, mechanically attached to, and electronically linked to the said first electronic device.

26. A conversion device for wireless communication as claim in claim 25, wherein the said module of the said conversion device for wireless communication therein uses USB (Universal Series Bus) as an interface thereby connects externally to the said first electronic device.

27. A conversion device for wireless communication as claim in claim 23, wherein the said wireless communication comprises one standard, or two standards, or combination of more than two standards such as Bluetooth, WiFi, NFC (Near Field Communication), wireless RF Transceiver.

28. A conversion device for wireless communication as claim in claim 23, wherein the said HID converted from the said second electronic device therein comprises therein one type, or two types, or combination of more than two types keyboard, mouse, touch pad, and touch screen therein used for input and control to the said first electronic device.

29. A conversion device for wireless communication as claim in claim 23, wherein the said functionality of the HID host is therein embedded in or externally connected to in the said first electronic device and the said second electronic device.
